(19) United States
(12) Patent Application Publication
(10) Pub. No.: US 2022/0396419 A1
(43) Pub. Date: Dec. 15, 2022

(54) Cartridge Receptacle, Cartridge System, Beverage Preparation Machine, and Method for Producing a Beverage

(71) Applicant: Freezio AG, Amriswil (CH)

(72) Inventors: Marc Krüger, Bergisch Gladbach (DE); Günter Empl, Bergisch Gladbach (DE)

(21) Appl. No.: 17/625,164

(22) PCT Filed: Jul. 15, 2020
(86) PCT No.: PCT/EP2020/069981

§ 371 Date: Jan. 6, 2022

(30) Foreign Application Priority Data
Jul. 15, 2019 (DE) 10 2019 119 144.0

(51) Int. Cl. B65D 85/804; A47J 31/44; A47J 31/52; B67D 1/00; B67D 1/08

(52) U.S. Cl. CPC B65D 85/8067; A47J 31/4403; A47J 31/52; B67D 1/0079; B67D 1/0888; B65D 85/8058; B65D 85/8052; B67D 2001/0811; B67D 2001/0814; B65D 2203/12

(57) ABSTRACT

Proposed is a cartridge system (1) for producing a beverage, said cartridge system (1) being insertable into a beverage preparation machine (3), wherein: the cartridge system (1) includes a cartridge (2), which has a reservoir (6) filled with a beverage substance (7); and a cartridge receptacle (10) connected to the cartridge (2), said cartridge receptacle (10) having a mixing chamber (8) that can be fluidically connected to the reservoir (6); and including a fluid supply (12) that leads to the mixing chamber (8); the cartridge system (1) further comprising an identification means for identifying the cartridge system in the beverage preparation machine (3).

### PRIOR ART

The present invention proceeds from a cartridge system, insertable into a beverage preparation machine, for producing a beverage, in particular a cold beverage, having a cartridge which has a reservoir filled with a beverage substance, and a cartridge receptacle which is reversibly connectable to the cartridge and into which the cartridge is reversibly insertable, and having a cartridge emptying device which effects an at least partial transfer of the beverage substance from the reservoir into a mixing chamber.

Such systems are known in principle from the prior art and are used to produce beverages from pre-portioned cartridges. The production of beverages with such systems is extremely convenient for the user since he merely has to insert a cartridge and press a start button. The beverage preparation machine then undertakes the production thereof in a fully automated manner, i.e., in particular, the beverage substance is blended with a predetermined quantity of liquid, in particular cold and carbonated water, and conveyed into a drinking vessel. In this way, in particular mixed drinks can be produced much more easily, quickly and with less effort for the user. The user can choose from a large number of different cartridges here, and so he can produce different drinks as desired.

One challenge with such systems is to ensure that the system is only operated with system-compatible cartridges and that no beverage preparation procedure is started if a system-incompatible cartridge is inserted into the system. This is the only way to ensure that when compressed air is blown in or a beverage preparation fluid is introduced under pressure, no malfunctions occur which could cause damage to the machine or endanger or injure the user, for example if the cartridge suddenly bursts due to the pressure of the gas or fluid introduced.

In addition, it is desirable to enable detection of the capsule type on the machine side so that parameters of the beverage preparation method, such as pressure, temperature, volumetric flow and introduction time of the beverage preparation fluid, can be adjusted and optimized accordingly.

### SUMMARY OF THE INVENTION

Therefore, it is an object of the present invention to provide a cartridge system, a beverage preparation machine, a system consisting of a cartridge system and a beverage preparation machine, and a method for producing a beverage in which identification of the cartridge in the beverage preparation machine is allowed.

This object is achieved by a cartridge system according to claim 1, a beverage preparation machine according to claim 16, a system according to claim 24, and a method according to claim 25.

Compared with the prior art, the invention has the advantage that the cartridge system is provided with an identification means with the aid of which the cartridge system can be identified in the beverage preparation machine. In this way, the beverage preparation machine cannot only verify that the cartridge system used is a system-compatible cartridge system, but also optionally read out parameters for the creation of this cartridge system. In this way, for example, the pressure, volumetric flow, temperature, introduction time, introduction duration, degree of carbonation and/or the like of the beverage preparation fluid to be introduced into the cartridge system and/or the pressure, volumetric flow, temperature, blow-in time, blow-in duration and/or the like of the compressed air to be introduced into the cartridge system can be predetermined. Furthermore, it is conceivable for the best-before date of the beverage contained in the cartridge to be stored in the identification means so that the beverage preparation machine can check whether the best-before date has not yet been exceeded. It is furthermore conceivable for the beverage preparation machine to use the identification means to detect whether there is an alcoholic substance in the cartridge or whether the cartridge is intended for the production of an alcoholic beverage. In such a case, an additional verification step may be provided, which is intended to perform an age and/or identification determination of the user, for example by means of a credit card, a fingerprint reader, a facial recognition, a login or password or the like.

Advantageous configurations and developments of the invention can be gathered from the dependent claims, and from the description with reference to the drawings.

According to a preferred embodiment of the present invention, provision is made for the identification means to comprise a coating, in particular in the form of a lacquer, an imprint or a foil, on an inner or outer surface of the cartridge and/or the cartridge receptacle. It is conceivable for the coating to comprise an optically readable code in the form of a marker, a pattern, a lettering, an image, a logo, a one-dimensional or multi-dimensional barcode, a bitcode or the like. It is also conceivable for the marker to reflect or absorb only light of certain wavelengths or wavelength ranges or represents a holographic image under irradiation of monochromatic light. In particular, the code is embedded in the marker, in the reflection or absorption characteristics or in the holographic image. It is also conceivable for the coating to have a special conductivity, thus, a certain electrical resistance, which represents the code, thus in particular the system affiliation. The code basically contains in particular data concerning the type of cartridge or cartridge system, the system affiliation, the above-mentioned parameters for carrying out the beverage production method and/or the best-before date. The coating representing the code can be stuck, printed, lacquered, shrunk, vaporized, sprayed or the like onto an inner or outer surface of the cartridge system. If the coating is applied to an inner surface of the cartridge system, then this coating is provided in particular for contactless reading, for example optically or via electromagnetic waves. In this case, the coating comprises in particular a material or a lacquer which is food-safe and thus approved for use in contact with food. If the coating is applied to an external surface, then reading based on direct contact can also be provided in the beverage preparation machine. It is conceivable for the lacquer or foil comprising the identification means to be protected by an additional protective foil which is applied to the lacquer or foil. The protective foil could, for example, be an at least partially transparent shrink tubing which is shrunk onto the cartridge. Alternatively, it would also be conceivable for the identification means to be realized as a coating or imprint on an inner side of the foil, thus, on that side of the foil which faces the cartridge or reservoir and/or is connected to the cartridge system. Advantageously, the identification means would then be protected by the remaining foil after application of the foil to the cartridge system. Preferably, the foil is then a multi-layer foil which is constructed from several foil layers lying one on top of the other, wherein in particular the innermost foil layer is provided with the identification means. It is also conceivable for the identification means to be arranged within the foil. The identification means preferably comprises a coating or imprint on an inner intermediate layer of the foil, which is configured as a multilayer foil. This intermediate layer is then protected on its two sides from external environmental influences by, in particular, transparent further layers of the foil. In particular, there is thus no need for an imprint of food coloring.

According to a preferred embodiment of the present invention, provision is made for the identification means to comprise an identification element which is in particular sleeve-shaped, tubular, c-shaped, annular and/or cylindrical which surrounds the cartridge and/or the cartridge receptacle at least in regions. Preferably, the identification means thereby surrounds a neck of the cartridge at least in regions. The neck preferably extends along a longitudinal axis of the cartridge system between the reservoir and the mixing chamber. It is conceivable for the identification means to be at least partially connected to the cartridge system in a material-fitting, force-fitting and/or form-fitting manner, in particular the identification means is clip-fastened, shrunk, plugged, pushed or stuck onto the cartridge, the cartridge receptacle or a neck of the cartridge. It is also possible that the identification element is welded, latched and/or pressed to the cartridge receptacle or the cartridge or the neck. The use of a c-shaped identification element has the advantage that it can be clip-fastened laterally. In turn, the readable code described above is embedded in the identification means. When using the identification means, which surrounds the cartridge and/or the cartridge receptacle at least in regions, direct contacting by contact elements of the retaining unit of the beverage preparation machine is possible in particular, as a result of which the code can be read out. For example, it is conceivable for the electrical conductivity or the ohmic resistance of the contact element to be read out and the code or the system affiliation of the cartridge to be checked through this.

In particular, the terms identification means and identification element and product identifier are used synonymously in the context of the present application.

According to an alternative preferred embodiment of the present invention, it is provided that the identification means or identification element is integrally connected to the cartridge, the cartridge receptacle and/or the neck and, in particular, is integrated into the cartridge, the cartridge receptacle and/or the neck. Preferably, therefore, no separate identification element is required for realization. It is conceivable for the identification means to comprise a marking region of the cartridge or the cartridge receptacle, which has a special electrical conductivity, a readable magnetization, an optically readable code in the form of a marker, a pattern, a lettering, an image, a logo, a one- or multi-dimensional barcode, particular reflection or absorption characteristics, an optically readable holographic image or readable quantum dots. Preferably, the identification means or the code can thus be embedded directly in the material of the cartridge receptacle or the cartridge.

According to a preferred embodiment of the present invention, provision is made for the identification element to be arranged inside the reservoir and/or the mixing chamber. Preferably, the identification means is thus protected from external environmental influences and in particular from external mechanical influences so that the risk of damage thereto is eliminated.

The identification means is preferably attached to the inner wall of the cartridge so that it can be read out optically from outside the cartridge if the cartridge wall is configured to be optically transparent. However, it would also be conceivable for the identification means to be a separate identification element, such as an RFID chip or a magnetic element, which is fixed or freely arranged in the reservoir or mixing chamber. When the cartridge system is manufactured, this element can simply be placed in the reservoir or mixing chamber. Alternatively, it is conceivable for the identification means to be an optically readable code arranged on the inside of an at least partially optically transparent wall of the reservoir or mixing chamber, in particular a one- or multi-dimensional barcode, a pattern or a hologram.

According to a preferred embodiment of the present invention, provision is made for the identification means to be configured such that it can be electrically contacted indirectly or directly by at least one contact element of the beverage preparation machine, in particular for measuring the electrical resistance of the identification means. In this case, the code is embedded in the electrical resistance of the identification means. For measuring the electrical resistance, preferably at least two contact points of the identification means must be contactable from outside the cartridge system. It is conceivable for the identification means to be either completely accessible from outside the cartridge system or at least two contact points of an identification means to be arranged inside the cartridge system or an identification means embedded in the material of the cartridge system to be led to the outside in order to be accessible from outside. In this context, the identification means is configured in particular such that it can be contacted by at least one contact element of the beverage preparation machine, in particular for a measurement of at least one physical parameter of the identification means. In other words, the identification means is configured in particular such that it can be electrically contacted by contact elements of the beverage preparation machine, in particular for a measurement of the electrical resistance and/or the electrical conductivity of the identification means.

According to a preferred embodiment of the present invention, provision is made for the cartridge receptacle to include a compressed-air connection opening into the reservoir for introducing compressed air into the reservoir.

According to a preferred embodiment of the present invention, provision is made for the cartridge receptacle to comprise a spike guide and a piercing means in the form of a piercing spike displaceably mounted within the spike guide, wherein the piercing spike is displaceable between an retracted position, in which the piercing spike is spaced apart from a sealing element of the cartridge, and a extended position, in which the piercing spike pierces the sealing element and projects into the reservoir, wherein the outer wall of the piercing spike has at least one side channel for directing the beverage substance toward the mixing chamber when the sealing element is pierced. This ensures that the fluid feed does not open into the reservoir of the cartridge, but into the mixing chamber separated from the reservoir. In this way, it is effectively prevented, in a manner that is simple and inexpensive to realize, that back-contamination of the beverage preparation machine occurs as a result of the fluid feed. For this purpose, the reservoir is not flushed by the fluid, but according to the present invention, the beverage substance and the fluid enter the mixing chamber separately from each other. The fluid is led directly into the mixing chamber, while the beverage substance is transferred to the mixing chamber by the cartridge emptying device and independently of the fluid. For this purpose, the cartridge receptacle according to the invention further comprises the piercing spike displaceably mounted in the spike guide. In the initial state of the cartridge receptacle, the piercing spike is in an retracted position and can be transferred from the retracted position to the extended position in order to open a sealing element of the cartridge. In the extended position, the sealing element is perforated by the piercing spike so that the beverage substance passes through the at least one side channel past the sealing element into the mixing chamber. Prior to this, the reservoir is closed by means of the sealing element, in particular in an air- and liquid-tight manner. Thus, a simple and reliable opening of a previously aroma-tight sealed cartridge in a beverage preparation machine is made possible. In addition, it has been shown that back-contamination of the beverage preparation machine is prevented in a much more effective manner than in the prior art, in particular because no overpressure acting directly on the fluid feed is generated in the reservoir. The configuration of the mixing chamber in the cartridge receptacle, which is reversibly insertable into the beverage preparation machine, advantageously ensures that the mixing chamber is part of the replaceable cartridge system. In this way, contamination of the beverage preparation machine by the beverage substance is effectively avoided because only parts of the replaceable disposable or reusable cartridge system come into contact with the beverage substance.

In accordance with a preferred embodiment of the present invention, the piercing spike is provided with an integral compressed-air line, wherein the compressed-air line extends along the piercing spike from a first end of the piercing spike to a second end of the piercing spike, wherein the compressed-air connection for connection to a compressed-air source is configured at the second end and a compressed-air outlet for blowing compressed air into the reservoir is configured at the first end.

In an advantageous manner, three functions are thus integrated into the piercing spike: 1. the piercing spike perforates the sealing element and thus opens the cartridge, 2. the piercing spike comprises at least one side channel to enable transfer of the beverage substance into the mixing chamber, 3. the piercing spike comprises the integrated compressed-air line, which is a cartridge emptying device, to blow compressed air into the reservoir, thereby forcing the beverage substance under pressure into the mixing chamber. In the sense of the present invention, the cartridge emptying device integrated into the cartridge receptacle thus initially comprises only a compressed-air connection, in particular a compressed-air line, through which compressed air can be introduced into the reservoir from the outside. The cartridge receptacle is configured such that the compressed air forces the beverage substance out of the reservoir and into the mixing chamber. The compressed air is provided in particular by the beverage preparation machine. It is conceivable for a compressed air source to be coupled directly to the compressed-air connection as soon as the cartridge system is inserted into the beverage preparation machine. This has the advantage that back-contamination in the direction of the beverage preparation machine is effectively prevented because the cartridge emptying device is immediately pressurized when the cartridge system is inserted, thus preventing beverage substance from migrating in the direction of the compressed-air connection and in particular in the direction of the compressed-air source of the beverage preparation machine. The beverage substance can thus move from the reservoir only in the direction of the mixing chamber. The compressed-air source is either a compressed-air tank or preferably an air feed pump, which feeds ambient air into the compressed-air connection and thus builds up an overpressure in the compressed-air connection. The air feed pump is started in time after coupling, during coupling or even before coupling (by a control unit or by the evaluation and control unit). Preferably, starting only takes place when the evaluation and control unit has detected a known capsule system on the basis of the identification means. It is conceivable for the air feed pump to be controlled as a function of the detected identification means, in particular the feed rate or thus the overpressure to be set as a function of the detected identification means.

According to a preferred embodiment of the present invention, provision is made for the piercing spike to have a plurality of side channels, wherein each side channel extends parallel to the piercing spike and wherein the side channels are each configured in the form of a groove which is open on one side and is inserted into the outer surface of the piercing spike. Preferably, the side channels are at least partially formed in a circumferential region of the piercing spike that is rearward to the cut surface. This has the advantage that the side channels are arranged on the side of the sealing element perforation where a cut has been made in the material, and not on the opposite side where the cut material is still connected to the remaining sealing element. The beverage substance can thus flow comparatively unhindered into the side channels.

It is conceivable for the cross-section of the side channels and/or the number of side channels to be adapted to the viscosity of the beverage substance, so that the side channels control or limit the flow of the beverage substance towards the mixing chamber. At a high viscosity, several side channels or side channels with a larger cross-section are used, while at a lower viscosity, fewer side channels or side channels with a smaller cross-section are provided. Thus, for each cartridge or cartridge receptacle there is a suitable piercing spike which is adapted to the respective beverage substance contained in the cartridge.

According to a preferred embodiment of the present invention, provision is made for the mixing chamber to have a beverage outlet through which the beverage produced from mixing the beverage substance with the fluid is dispensed, wherein the cartridge receptacle is preferably configured such that the beverage can be introduced from the beverage outlet directly into a portable vessel. In a preferred manner, neither the beverage substance nor the beverage produced thus comes into contact with any part of the beverage preparation machine, so that almost any (back-)contamination of the beverage preparation machine is prevented. The fluid is fed separately to the mixing chamber. Preferably, the fluid is fed into the mixing chamber under pressure. In particular, the fluid is provided by the beverage preparation machine. Preferably, the beverage preparation machine has a fluid feed pump which pumps the fluid from a tank of the beverage preparation machine into the mixing chamber as soon as the fluid feed pump is switched on. It is conceivable for a fluid source to be coupled directly to a corresponding fluid connection of the cartridge receptacle as soon as the cartridge system is inserted into the beverage preparation machine. The fluid connection is in fluid communication with the mixing chamber via a fluid line. The fluid feed pump is started chronologically after coupling, during coupling or even before coupling (if the fluid connection is provided with a valve, for example, which only opens during coupling), in particular by a control unit or by the evaluation and control unit. Preferably, starting only takes place if the evaluation and control unit has recognized a known capsule system on the basis of the identification means. It is conceivable for the fluid feed pump to be controlled as a function of the detected identification means, in particular the feed rate is set as a function of the detected identification means. Starting the fluid feed pump before or during coupling has the advantage of effectively preventing back-contamination in the direction of the beverage preparation machine, because the fluid connection is immediately pressurized when the cartridge system is inserted and thus beverage substance is prevented from migrating in the direction of the fluid line and, in particular, in the direction of the fluid source of the beverage preparation machine. The beverage substance and the beverage can thus move from the mixing chamber only in the direction of the beverage outlet. The fluid comprises in particular water, preferably pressurized, cooled and/or carbonated drinking water. It would be conceivable to provide the beverage outlet with a closure which closes the beverage outlet after use. In this way, dripping of the produced beverage from the beverage outlet could be prevented. Furthermore, it is conceivable for the beverage outlet to able to be pivoted and/or adjusted in height. This would allow the beverage outlet to be adjusted to the geometry of the portable vessel.

According to a preferred embodiment of the present invention, provision is made for the cartridge or cartridge system to have a product identifier that is embedded, in particular, in an optically readable code, a one-dimensional or multidimensional bar code, a bit code, an RFID code, a QR code, a data matrix code, a color code or a hologram code. In a preferred manner, this enables automatic reading of the product identifier. In particular, the product identifier serves to indicate the beverage substance contained in the cartridge. It is conceivable for the product identifier to be used to set operating parameters of the beverage preparation machine, such as feed rate, feed time, feed pauses, temperature, degree of carbonation, and/or pressure of the fed fluid and/or the fed compressed air. This is done in an evaluation and control unit of the beverage preparation machine, which comprises a plurality of pre-stored beverage production programs that differ in the operating parameters of the beverage preparation machine. Each beverage production program is associated with one or more product identification codes. When the cartridge is inserted, the product identifier is read by the identifier detector. The evaluation and control unit then selects the beverage production program corresponding to the product identifier. In this way, optimum operating parameters can be set for each beverage to be produced; in particular, the starting and stopping times, running time, and feed rate of the fluid feed pump and/or the air feed pump are set individually for each beverage. It is also conceivable for these operating parameters to be embedded directly in the product identifier. The evaluation and control unit reads and evaluates the operating parameters from the product identifier and controls the beverage preparation machine and in particular the fluid feed pump and/or the air feed pump accordingly. In this variant, no pre-stored beverage production programs need to be stored in the beverage preparation machine. The product identification means can either be the identification means introductorily described or the cartridge system has both the identification means described above and a separate product identification means. For example It is conceivable for the system affiliation to be only checked by means of the identification means, while the type of beverage substance, the beverage to be produced or the operating parameters of the beverage preparation machine are determined by means of the product identification means (or vice versa).

Furthermore, it is conceivable for the identification means to be only used for checking the authenticity or the best-before date of the cartridge. Furthermore, only for cartridges containing alcoholic beverage substances, it is conceivable to be equipped with an identification means so that an age check (see above) is performed on the part of the beverage preparation machine.

Furthermore, it is conceivable for the beverage production process to not even start if no product identifier can be identified or the identified product identifier does not match any pre-stored beverage production program. In this case, the recognition of an “authenticated cartridge system” carried out in the second method step fails. This prevents the use of a system-incompatible cartridge in the beverage production machine that is not certified for operation in the beverage production machine, which would pose a risk of damage to the beverage production machine or a hazard to the user, for example due to bursting of the cartridge (if it is intended for operation at lower pressures).

The product identifier is preferably applied to the wall of the cartridge, in particular printed or stuck on. However, it would also be conceivable to apply the product identifier to the sealing element (in particular the sealing foil) for sealing the cartridge opening. In particular, the product identifier is positioned on the cartridge such that the product identifier is arranged within the range of detection of the identifier detector of the beverage preparation machine when the cartridge is inserted into the beverage preparation machine. Alternatively, it would also be conceivable for the product identifier not to be arranged on the cartridge, but in an appropriate manner on an outer wall of the cartridge receptacle.

According to a preferred embodiment of the present invention, provision is made for a shaping of at least a partial region of the cartridge system to act as an identification means. It is conceivable for this shaping of the partial area to be detectable by an optical or mechanical sensor of the beverage preparation machine and for the compatibility and/or the type of cartridge system used to be detected on the basis of the detected shaping. It is also conceivable for the shaping to comprise the surface condition of the partial area, for example, the product identifier comprises a specific structuring. The beverage preparation machine then uses the detected structure to determine the cartridge system.

According to a preferred embodiment of the present invention, provision is made for the beverage substrate to act as an identification means. Preferably, the conductivity of the beverage substance, in particular liquid, in the reservoir is measured when the cartridge system is inserted into the beverage preparation machine, and the conductivity is then used to determine the type of cartridge system, the compatibility of the cartridge system used and/or the beverage substance type. It is conceivable for the beverage preparation machine to comprise a contact element with a piercing tip so that the contact element can be pierced through the cartridge wall from outside the cartridge in order to measure the conductivity of the beverage substance inside the cartridge. It is conceivable for the contact element to be subsequently pulled out of the wall again and for the wall to be designed to be self-sealing. It would also be possible for a through-opening to be provided in the cartridge wall in the region of the contact element, which is sealed with a preferably self-sealing and pierceable sealing foil. In particular, beverage substances in the form of syrup can be distinguished from one another on the basis of different pH values and sugar contents, which result in different conductivity of the syrup.

The beverage preparation machine according to the invention for producing a beverage, into which the cartridge system according to the invention can be inserted, has a retaining unit into which the cartridge receptacle connected to the cartridge can be inserted. The beverage preparation machine also preferably has at least one identifier detector, in particular for optical reading of the identification means, for example in the form of an optical camera (CCD camera) or a scanner. Furthermore, it is conceivable for the beverage preparation machine to have a light source for optically illuminating the identification means.

Furthermore, the beverage preparation machine preferably comprises a control unit to verify the read-out identification means. It is conceivable for the control unit to compare the identification means read out with a reference in order to check whether it is a known or approved identification means and the associated cartridge system is thus authenticated. It is also conceivable for the control unit to read a code underlying the identification means when reading it out and to compare this code with a reference code or otherwise check it, for example using an algorithm, in order to recognize in this way whether it is an approved code and the associated cartridge system is thus authenticated. It is conceivable for the beverage preparation machine to have an internal memory in which a large number of references or reference codes are stored, each of which is used for authentication. In the present application, the control unit is optionally also referred to as the evaluation and control unit. In particular, this is one and the same unit.

It is also conceivable for the retaining unit to have at least one contact element that contacts the identification means of the cartridge system in order to determine at least one physical parameter of the identification means for identifying the cartridge system. In a preferred manner, the physical parameter, in which in particular the code is embedded or via which the identification means can be read, can be used to check the system affiliation of the cartridge system. Furthermore, it is conceivable for the beverage preparation parameters to be read out. Preferably, the beverage preparation machine comprises a measuring unit connected to the at least one contact element for measuring the electrical resistance and/or the electrical conductivity of the identification means.

According to a preferred embodiment of the present invention, provision is made for the beverage preparation machine to have a fluid source for feeding a fluid into the fluid feed and a compressed air source for blowing compressed air into the compressed-air connection.

According to a preferred embodiment of the present invention, provision is made for the retaining unit to comprise a release element for transferring a piercing means of the cartridge receptacle from a retracted position to an extended position. In the extended position, a piercing spike of the piercing means is forced through and perforates a sealing means closing the beverage reservoir. In order to keep the beverage reservoir sealed when not in use and to protect the piercing spike from damage, the piercing spike is not pushed through the sealing means by the piercing means when not in use, but is retracted in a protected position. However, the piercing spike must be extended for the piercing process of the sealing element. For this purpose, the piercing means extends and moves the piercing spike into the extended position. The extending of the piercing means is initiated here in a preferred manner by the release element of the retaining unit. The separation of the release mechanism on the retaining element on the one hand and the piercing means with the piercing spike on the cartridge receptacle on the other hand ensures that the piercing spike only extends when the cartridge receptacle is inserted into the retaining unit. It is also conceivable for the release mechanism to be geometrically encoded so that the piercing means is only extended when a cartridge receptacle encoded in accordance with the release mechanism is inserted. Furthermore, it is possible that the release mechanism is positioned such that the piercing means only extends when the cartridge receptacle is inserted in the correct position in the retaining element. Furthermore, it is possible that the trigger mechanism is configured such that the piercing means only extends if the cartridge receptacle is not inserted at an angle to the intended insertion direction and/or is not inserted far enough into the retaining device.

According to a preferred embodiment of the present invention, provision is made for the retaining unit to comprise a fastening flange which engages around the cartridge receptacle in a form-fitting and/or force-fitting manner during or after insertion into the retaining unit. The form-fitting and/or force-fitting connection of the retaining unit to the cartridge receptacle via the fastening flange ensures that the cartridge receptacle is securely positioned in the retaining unit. The fastening flange can absorb and dissipate forces acting on the cartridge receptacle. Forces which arise during operation of the beverage preparation machine, caused for example by the compressed air applied, are conceivable here. However, the fastening flange can also absorb and dissipate forces that act on the cartridge receptacle from outside. For example, a bump by the user would be conceivable here. Thus, the correct positioning of the cartridge receptacle in the retaining unit can be ensured in a preferred manner.

Preferably, provision is made for the fastening flange to be coupled to a manually or motor-driven release mechanism which is provided for displacing the fastening flange such that a relative movement is generated between the cartridge receptacle and the release element in contact with the piercing means, whereby the piercing spike is transferred from the retracted position to the extended position. The cartridge receptacle is thus moved by the fastening flange against the stationary release element, so that the stationary release element presses against the piercing spike and moves it from the retracted position to the extended position. This perforates the sealing foil and the beverage production process starts. In this way, it is ensured in a preferred manner that the piercing spike is extended when the cartridge receptacle is in the position provided for piercing the sealing agent. This prevents damage to the piercing spike, which could be caused, for example, by piercing next to the sealing agent or by contact between the piercing spike and the point provided for piercing at an angle not provided for piercing. In particular, the release element is configured to be stationary and causes the piercing spike to be displaced from the retracted position to the extended position by the cartridge system being moved by the release mechanism relative to the stationary release element. The release element is in particular a fixed projection on the retaining element.

Preferably, provision is made for the release mechanism to comprise an operating lever for manual actuation thereof, wherein the operating lever is preferably configured to be rotatable about an axis of rotation substantially parallel to the longitudinal axis of the cartridge. The manual actuation of the release mechanism preferably reduces the force required to insert the cartridge receptacle into the retaining unit. Piercing the sealing agent with the piercing spike requires a certain amount of force. With the aid of the operating lever, this force can be applied conveniently and ergonomically by the user and does not have to be applied solely by inserting the cartridge receptacle into the retaining unit. Fixing the operating lever so that it can rotate on an axis of rotation essentially parallel to the longitudinal axis of the cartridge enables a preferred mechanical leverage effect on the release mechanism when the operating lever is actuated. The operating lever can also be provided with an anti-slip surface and/or shape. This allows the release mechanism to be operated in a particularly preferred manner. Good mechanical coupling of the user to the release mechanism allows it to be operated with particular sensitivity, thus protecting the piercing means from damage.

Preferably, provision is made for the release mechanism to comprise a transmission gear which translates a rotary movement of the operating lever about the axis of rotation parallel to the longitudinal axis into a translational movement essentially parallel to the longitudinal axis and, in particular, into a raising or lowering of the retaining unit and/or cartridge receptacle. This enables, in a particularly preferred manner, the transmission of force from the actuation of the operating lever to the piercing of the sealing agent by the piercing spike. The rotary movement of the operating lever results in a straight relative movement between the sealing agent and the piercing spike. This means that there is no tilting during piercing.

According to a preferred embodiment of the present invention, provision is made for the cartridge and/or the cartridge receptacle to have a product identifier and for the beverage preparation machine or the cartridge receptacle to have an identifier detector for identifying the product identifier. Preferably, the product identifier is embedded in a barcode, an RFID code, a QR code, a data matrix code, a color code, a hologram code or the like. Advantageously, automated reading of the product identifier is thus possible. The identifier detector comprises in particular an optical sensor, for example a CCD camera, which automatically reads the barcode or QR code or data matrix code when the cartridge has been inserted into the beverage preparation machine. Alternatively, the identifier detector comprises a transceiver antenna for automatically reading the RFID code. Alternatively, it would be conceivable for the product identifier also to be embedded in other automatically readable computer chips. The term QR code includes, within the meaning of the present invention, in particular any data matrix code. In this regard, the terms QR code and data matrix code are used synonymously. Alternatively or additionally, it would also be conceivable for the product identifier to comprise a barcode, a dot code, a binary code, a Morse code, Braille code (embossed printing) or the like. The code can in this case also be embedded in a three-dimensional structure, for example a relief. The product identifier comprises in particular what is known as the product identification number, in particular a Universal Product Code (UPC), a European Article Number (EAN), a GS1 code, a Global Trade Item Number (GTIN) or the like. In this way, it is not necessary for a new code system to be introduced. In particular, the product identifier is covered by the GS1 standard.

The product identifier serves in particular to specify the beverage substance located in the cartridge. During or before the start of the beverage preparation process, the product identifier is read with the identifier detector. Thus, the beverage preparation machine knows which type of cartridge has been introduced into the beverage preparation machine. It is conceivable for an evaluation and control unit of the beverage preparation machine to have a multiplicity of prestored beverage production programs which are provided for the preparation of different beverages and differ from one another for example in terms of the feed rate, feed time, feed pauses, temperature, degree of carbonation and/or pressure of the fluid fed. It is also conceivable for different compressed-air feeds (for example at different pressures) to be used in different beverage production programs. Each beverage production program is linked to one or more product identifiers. When a cartridge is introduced into the beverage preparation machine, the product identifier on the cartridge is read with the identifier detector and then compared with the prestored data. Using the product identifier, a beverage production program is thus selected from the plurality of prestored beverage production programs and subsequently the beverage production process with the selected beverage production program is started. The parameters such as feed rate, feed time, feed pauses, temperature, degree of carbonation and/or pressure of the fluid fed are predetermined or controlled by the selected beverage production program in order to achieve optimal results for the beverage to be produced with the particular beverage substance.

It is conceivable for the beverage production process not to start at all when a product identifier is not identifiable or the identified product identifier does not match any prestored beverage production program. This prevents a system-incompatible cartridge from being used in the beverage production machine, which is not certified for operation in the beverage production machine, with the result that there would be the risk of damage to the beverage production machine or a hazard to the user, for example by bursting of the cartridge (when the latter is intended for operation at lower pressures).

The product identifier is preferably printed or stuck on the wall of the cartridge or on the sealing element (in particular the sealing foil) for sealing off the cartridge opening. In particular, the product identifier is positioned on the cartridge such that the product identifier is arranged within the range of detection of the identifier detector of the beverage preparation machine when the cartridge has been inserted into the beverage preparation machine. Alternatively, it would also be conceivable for the product identifier not to be arranged on the cartridge but in an appropriate manner on an outer wall of the cartridge receptacle. Alternatively, it would also be conceivable for the product identifier to be integrated into the beverage substance.

The conductivity measurement can be used, for example, to determine the beverage substance and thus the type of cartridge system. In this case, the contact element for measuring the conductivity is inserted into the reservoir, in particular, in order to come into contact with the beverage substance. It is conceivable for the cartridge wall to be pierced by the contact element for this purpose. After the measurement, the contact element is optionally moved out of the reservoir again, wherein the resulting hole in the wall is then preferably closed again, or the contact element remains partially in the reservoir during the beverage production process.

It is also conceivable for the evaluation and control unit of the beverage preparation machine to register which cartridges and/or how many cartridges of a particular type have been used. Preferably, the beverage preparation machine has a communication module which is provided for communication between the beverage preparation machine and a central service provider by means of an Internet connection. The central service provider may be, for example, a server of the manufacturer of the beverage preparation machine that remotely monitors the status of the beverage preparation machine and/or maintains, monitors, and/or repairs the beverage preparation machine, if necessary. It is conceivable for the central service provider to be able, for example, to check the firmware or software of the beverage preparation machine and update it if necessary and/or restart the beverage preparation machine. It is also conceivable for new beverage production programs to be installed (if, for example, new cartridges are launched on the market) and/or the parameters such as feed rate, feed time, feed pauses, temperature, degree of carbonation and/or pressure of the fed fluid to be adjusted. Preferably, the beverage production machine has a plurality of sensors which can be read by the central service provider so that, for example, the degree of contamination, the degree of wear, the filter conditions, the pump pressure and the like can be monitored. It is also conceivable for operating parameters of the beverage preparation machine to be read out, providing information about the number of beverage production processes already carried out. It is conceivable, for example, for the evaluation and control unit to transmit data to the central service provider showing which and how many cartridges of a particular type have been used, so that, for example, targeted advertising (for example on the display of the beverage preparation machine or on an associated APP) can be switched on for the preferred beverages and/or automatic reorders for the used cartridges can be placed. Preferably, the display of the beverage production machine can be used to reorder cartridges, which is transmitted directly to the central service provider via the communication module. It is also conceivable for voice control of the beverage production machine to be implemented, with the voice data for controlling the machine being recorded by a microphone of the beverage production machine and then transmitted to the central service provider via the communication module for evaluation. Furthermore, it is conceivable for the beverage production machine to provide a user-sensitive operating mode with, for example, personalized menus or settings comprising, for example, individually selected parameters or beverage production programs, the user selection being made on the basis of a password or biometric data, such as facial recognition, iris scan or fingerprint. The data collected is in particular transmitted in encrypted form to the central service provider or evaluated there for activation or transmission of the personalized menu to the corresponding beverage production machine. It is conceivable for the user to always be able to automatically load his/her individual menu and/or individual settings at different beverage production machines.

According to a preferred embodiment of the present invention, provision is made for the retaining unit to comprise a fastening flange which engages around the cartridge receptacle in a form-fitting and/or force-fitting manner during or after insertion into the retaining unit.

According to a preferred embodiment of the present invention, provision is made for the contact element to be integrated into the fastening flange.

The system according to the invention comprises the beverage preparation machine according to the invention and the cartridge system according to the invention that can be inserted into the retaining unit.

In the method for preparing the beverage according to the invention, which is carried out in particular with the system according to the invention, the following steps are carried out: inserting the cartridge system into the retaining unit of the beverage preparation machine in a first method step, detecting the identification means of the cartridge system in a second method step, and starting a beverage preparation process in a third method step if an authenticated cartridge system has been detected in the second method step.

The beverage preparation process started in the third method step then comprises a first preparation step, which comprises feeding a fluid into the mixing chamber (8) through the fluid feed, a second preparation step which comprises transferring the beverage substance from the reservoir (6) into the mixing chamber (8) by feeding compressed air into the reservoir (6), and a third preparation step which comprises discharging the beverage produced in the mixing chamber (8) by mixing the beverage substance with the fluid by means of a beverage outlet. Advantageously, the actual beverage production and provision is only carried out by the first, second and third preparation steps, which, however, are only started when a known or permitted identification means or an identification means recognized as system-specific has been verified in the second method step or a code could be extracted from the identification means which can be verified as known or permitted or as system-specific. It is also conceivable that in the second method step operating parameters are exclusively or additionally read out from the identification means or the code and that the beverage system is only considered authenticated if such operating parameters are detectable. The operating parameters are used to control the air feed pump, the fluid feed pump and/or to start or control the release mechanism and/or to unblock the release mechanism in order to perform the handling step.

In a preferred manner, the beverage production process is thus only started if the check of the detected identification means was successful in the second method step. In particular, the identifier detector or the evaluation and control unit described above (later also referred to as the control unit) of the beverage preparation machine is used for this purpose. With the aid of the evaluation and control unit, the detected identification means is evaluated and, if necessary, a code underlying the identification means is detected (as described in detail earlier in this application).

The first preparation step and the second preparation step are started, in particular, either simultaneously or one after the other, wherein preferably the first preparation step is started before the second preparation step, wherein in particular a time offset between the first and the second preparation step of between 1 millisecond and 2 seconds, preferably between 100 milliseconds and 1.5 seconds and particularly preferably between 500 milliseconds and 1 second is waited for before the second preparation step is also started after the start of the first preparation step. This has the advantage, among other things, that the mixing chamber is first filled or flushed with the fluid before beverage substance enters the mixing chamber. In this way, pure beverage substance, for example thick syrup, cannot escape from the beverage outlet at any time, but is inevitably always first mixed and diluted with fluid, in particular with water. This increases safety, in particular with alcoholic beverages.

It is conceivable for the cartridge system to be engaged around by a release mechanism in a handling step and to be moved relative to a release element of the retaining unit, in particular to be lowered against a fixed release element, wherein the release element contacts the piercing spike and, in particular, transfers it from the retracted position to an extended position. Advantageously, the handling step causes the sealing element to be pierced so that beverage substance can enter the mixing chamber and compressed air can be blown into the reservoir. The handling step is preferably carried out between the first and second method steps or as the zeroth preparation step as part of the beverage preparation process. It is conceivable for the release mechanism to be initially blocked by a blocking device of the retaining unit, which only releases the release mechanism when an authenticated cartridge system has been detected in the second method step. The handling step is carried out here or independently thereof, in particular by manual actuation of a hand lever by the user of the beverage preparation machine. Alternatively, it is conceivable for the release mechanism to be motor-driven (as detailed above) and to be performed by a control unit of the beverage preparation machine or to be controlled by the evaluation and control unit. It is conceivable for the motor-driven release mechanism to be activated automatically by the evaluation and control unit when an authenticated cartridge system has been detected in the second method step. In this case, the handling step is part of the beverage production process as the zeroth preparation step.

Preferably, in the first method step or in the handling step, a fluid connection is established between a fluid source of the beverage preparation machine and the fluid feed of the cartridge receptacle (this does not automatically mean that fluid is already flowing towards the mixing chamber, but only that the lines or connections are interconnected). In particular, the fluid is not fed towards the mixing chamber until the fluid feed pump is activated (as described above and below in the present application).

Preferably, in the first method step or in the handling step, a compressed-air connection is established between a compressed-air source of the beverage preparation machine and the compressed-air connection of the cartridge receptacle (this does not automatically mean that compressed air is already blown into the reservoir, but only that the lines or connections are interconnected). In particular, the compressed air is not delivered towards the reservoir until the air feed pump is activated (as described above and below in the present application).

In the first preparation step, a fluid feed pump of the beverage preparation machine is switched on in particular to feed the fluid into the mixing chamber, wherein the fluid feed pump is only switched on by a control unit if an authenticated cartridge system has been detected in the second method step. The fluid is taken by the fluid feed pump, in particular from a fluid tank, and conveyed in the direction of the mixing chamber through the fluid feed.

In the second preparation step, in particular a compressed-air source in the form of an air feed pump of the beverage preparation machine is switched on to feed the compressed air into the reservoir, wherein the compressed-air source is switched on by a control unit only if an authenticated cartridge system has been detected in the second method step. The air feed pump thereby optionally pumps ambient air through an air inlet towards the reservoir preferably through the compressed-air inlet, the compressed-air line, the compressed-air outlet and the channel inside the piercing spike.

It is conceivable for the control unit to determine operating parameters as a function of the identification means in the second method step, and for the control unit to control the fluid feed pump and/or the air feed pump as a function of the operating parameters, wherein the operating parameters preferably comprise starting time, stopping time, running time and/or feed rate of the fluid feed pump and/or the air feed pump. In the second method step, the evaluation and control unit or the control unit not only checks whether the detected identification means or the read-out code indicates a system-specific, thus authenticated cartridge system, but also reads out operating parameters from the identification means or the code, which are used in the beverage preparation process (details on verifying and reading out the identification means or code are explicitly described above in connection with the beverage production machine and the cartridge system, to which reference is hereby made). An individual beverage preparation process can thus be started for each cartridge system in order to generate an optimum beverage result. In particular, the operating parameters and programs do not all have to be already stored in an internal memory of the beverage preparation machine even when the beverage preparation machine is delivered, but new operating programs can also be generated later via the identification means or the code.

In the second method step, a code arranged on the cartridge system is read out optically, wherein preferably the read-out code is checked by the control unit by means of an algorithm or by comparison with one or more reference codes (see explanations above in connection with the beverage preparation machine and the cartridge system).

In an alternative embodiment, it is conceivable for the piercing spike to be transferred from the retracted position to the extended position in the first preparation step not by the above-mentioned release element but by the compressed air, wherein the sealing element is perforated by the transfer of the piercing spike from the retracted position to the extended position.

Preferably, the method according to the invention further comprises the following steps:
inserting the cartridge system into the retaining unit of the beverage preparation machine,
establishing contact between a contact element of the retaining unit and the identification means of the cartridge system,
measuring a physical parameter of the identification means by means of a measuring unit and checking the system affiliation of the cartridge system on the basis of the physical parameter,
establishing a fluid connection between a fluid source of the beverage preparation machine and the fluid feed of the cartridge receptacle,
establishing a compressed air connection between a compressed-air source of the beverage preparation machine and the compressed-air connection of the cartridge receptacle,
perforating the sealing element by transferring the piercing spike from the retracted position to the extended position,
transferring the beverage substance from the reservoir to the mixing chamber by feeding compressed air into the reservoir,
feeding a fluid into the mixing chamber through the fluid feed and discharging the beverage produced in the mixing chamber by mixing the beverage substance with the fluid by means of a beverage outlet.

The method steps listed above are not to be regarded as an obligatory chronological sequence, but can also be carried out simultaneously or in a different order. Preferably, for example, the actuation of the cartridge emptying device and the feeding of the fluid are carried out in parallel. It is conceivable for the steps of establishing the fluid and/or compressed-air connection and/or feeding the fluid to be carried out only if it has been verified on the basis of the physical parameter that the cartridge system is a system-related cartridge system, i.e. an approved or known cartridge system.

According to a preferred embodiment of the present invention, provision is made for an additional product identifier to be read out by an identifier detector and evaluated and, in particular, verified by a control unit before the fluid and/or compressed-air connection is made and/or before the sealing element is perforated, wherein preferably the product identifier is illuminated by the light element during the read-out. By reading out the product identifier, operating parameters such as the temperature or degree of carbonation of the fluid or the operating pressure of the compressed-air connection can be set. Furthermore, by reading out the product identifier from the identifier detector, it can be detected whether the cartridge is intended for use with the beverage preparation machine. If this is not the case, perforation of the sealing agent could be omitted, thus protecting the piercing spike from damage caused by, for example, an unsuitable sealing agent. Illumination of the product identifier also facilitates optical reading.

According to a preferred embodiment of the present invention, provision is made for the fluid to be cooled and/or carbonated before being fed into the mixing chamber. Thus, cold beverages and carbonated cold beverages can be produced.

According to a preferred embodiment of the present invention, provision is made for the piercing spike to be transferred from the retracted position to the extended position by a release element of the beverage preparation machine, wherein the cartridge receptacle is preferably moved against the stationary release element in such a way that the piercing spike is transferred from the retracted position to the extended position. The piercing spike thus perforates the sealing agent. In a preferred manner, the reservoir is thus opened automatically so that the beverage substance can be transferred to the mixing chamber. It is conceivable for compressed air and fluid to already be introduced into the cartridge receptacle during the opening process so that back-contamination of the beverage preparation machine is prevented by beverage substance.

According to a preferred embodiment of the present invention, provision is made for the cartridge receptacle to be engaged around by a fastening flange of the retaining unit during or after insertion of the cartridge system into the retaining unit, and wherein the fastening flange is operated and, in particular, displaced by a manually or motor-driven release mechanism in such a way that a relative movement is generated between the capsule receptacle and the release element being in contact with the piercing spike, whereby the piercing spike is transferred from the retracted position to the extended position. This advantageously causes, on the one hand, forces acting on the cartridge system, such as pressure from the user during the insertion process, to be absorbed and dissipated by the fastening flange. On the other hand, this causes the piercing spike to be extended from a protected retracted position to an extended position for perforating the sealing agent of the reservoir when the cartridge receptacle is in the correct position. Perforating the sealing agent starts the beverage production.

According to a preferred embodiment of the present invention, provision is made for the cartridge wall to be pierced by the contact element in order to establish contact between a contact element and the identification means. Here, it would be conceivable for the product identifier to be integrated into the beverage substance. By means of the conductivity measurement, for example, the beverage substance and thus the type of cartridge system can be determined. In particular, the contact element for measuring conductivity is inserted into the reservoir in order to come into contact with the beverage substance. It is conceivable that the cartridge wall is pierced by the contact element for this purpose. After the measurement, the contact element is optionally moved out of the reservoir again, wherein the resulting hole in the wall is then preferably closed again, or the contact element remains partially in the reservoir during the beverage production process.

Further details, features and advantages of the invention are apparent from the drawings, and from the following description of preferred embodiments with reference to the drawings. The drawings illustrate merely exemplary embodiments of the invention which do not limit the essential concept of the invention.

### BRIEF DESCRIPTION OF THE DRAWINGS

FIG. 1 shows a schematic view of the beverage preparation machine without inserted cartridge receptacle according to an exemplary embodiment of the present invention.

FIG. 2 shows a schematic view of the cartridge system according to an exemplary embodiment of the present invention.

FIG. 3 shows a schematic view of the beverage preparation machine with a cartridge system inserted into the beverage preparation machine according to an exemplary embodiment of the present invention.

FIGS. 4a to 4c show the basic principle of the method for producing a beverage with the cartridge system inserted in a beverage preparation machine according to an exemplary embodiment of the present invention.

FIG. 5 shows a schematic view of the cartridge system according to further exemplary embodiments of the present invention.

FIGS. 6a and 6b schematically show the reading of the product identifier of the system according to the invention.

FIG. 7 shows a schematic view of the beverage preparation machine with a cartridge system inserted in the beverage preparation machine according to another exemplary embodiment of the present invention.

FIG. 8 schematically shows the steps of the method for producing a beverage according to the invention.

### EMBODIMENTS OF THE INVENTION

In the various figures, identical parts are always provided with the same reference signs and are therefore each generally also mentioned only once.

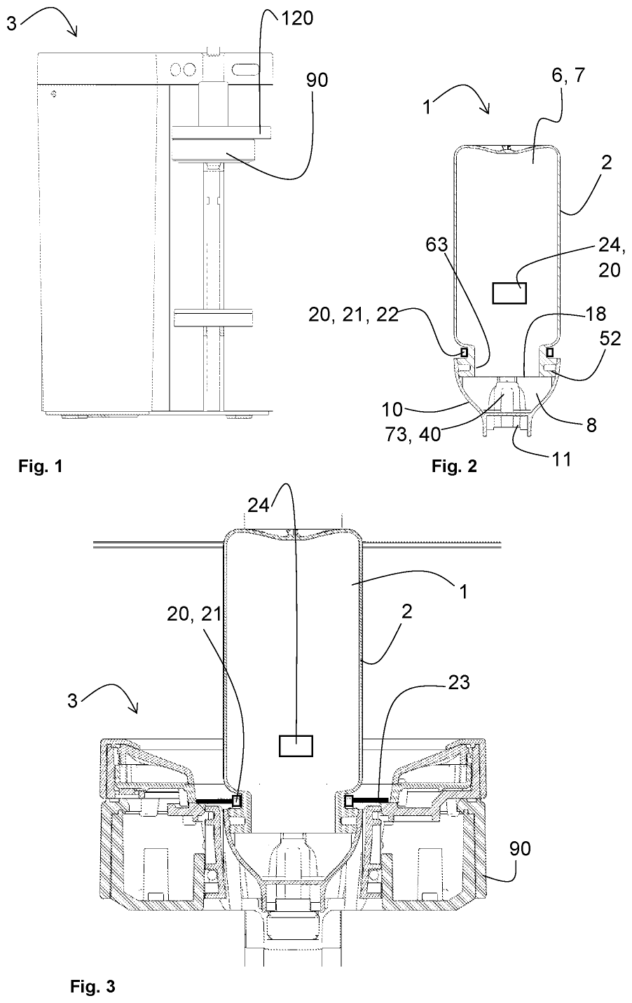

FIG. 1 shows a schematic view of a beverage preparation machine 3 without an inserted cartridge receptacle according to an exemplary embodiment of the present invention.

The beverage preparation machine 3 comprises a retaining unit 90 for receiving a cartridge system 10 (see FIG. 2). The retaining unit 90 comprises an operating lever 120 for manually operating a release mechanism for extending a piercing spike 73 of the cartridge receptacle 10 for piercing a sealing agent 18. When the user rotates the operating lever 120, the trigger mechanism for extending the piercing spike is actuated. In this case, the release mechanism in particular moves the cartridge system 19 downwards in or with the retaining unit 90 so that the piercing spike 73 strikes against a stationary release element of the retaining unit 90 and is thereby transferred upwards in the direction of the extended position in which the sealing agent 18 is perforated.

FIG. 2 shows a schematic view of the cartridge system 1 according to an exemplary embodiment of the present invention.

The cartridge system 1 comprises a cartridge 2, which comprises a reservoir 6 filled with a beverage substance 7 and a cartridge opening 63. In the initial state, the cartridge opening 63 is sealed with a sealing agent 18 in the form of a foil. In the region of the cartridge opening 63, the cartridge 2 comprises a neck which is provided with circumferential retaining flanges 52.

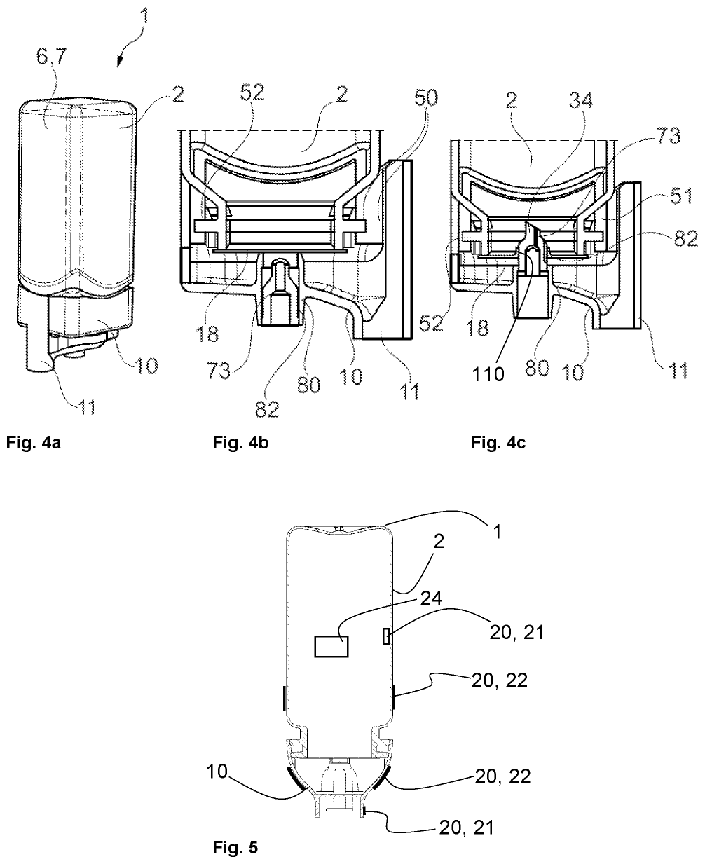

The cartridge system 1 further comprises a cartridge receptacle 10, which is placed on the neck and is in particular connected or latched to the retaining flanges 52. The cartridge receptacle 10 comprises a mixing chamber 8, a beverage outlet 11 leading out of the mixing chamber 8 for a beverage produced in the mixing chamber 8, and a fluid feed 12 (see FIGS. 4a to 4c) opening into the mixing chamber 8, through which a liquid, in particular cooled and/or carbonated water, is introduced into the mixing chamber 8.

The cartridge receptacle 10 furthermore comprises a spike guide 80, in which a piercing spike 73 is displaceably guided. The piercing spike 73 is shown in a retracted position in FIG. 1.

In the exemplary embodiment of the present invention shown in FIG. 2, the cartridge receptacle 10 preferably comprises an identification means 20. The identification means 20 is formed as an identification element 21, which comprises the neck of the cartridge 2. The identification element 21 is either configured in an annular shape and surrounds the neck completely, i.e. along its entire circumference, or the identification means 21 is configured in a c-shape so that it surrounds the neck only partially, i.e. does not extend along the entire circumference of the neck. If the identification means 21 is c-shaped, it is preferably clip-fastened laterally onto the neck. If the identification means 21 is annular, thus in particular also sleeve-shaped and/or cylindrical, the identification element 20 is preferably connected to the neck in a force-fitting, material-fitting or form-fitting manner, in particular stuck on, welded on, shrunk on, pressed on, pushed on, plugged on or the like. Alternatively, it is conceivable for the identification means 20 to comprise a coating 22 which is applied to the neck as a lacquer or adhesive film or label, in particular lacquered on, sprayed on, vapor-deposited or glued on. The identification element 21 preferably comprises a defined electrical conductivity, which can be measured by means of contact elements 23 of the retaining unit 90. For this purpose, the identification element 20 is optionally made at least partially of metal or of an electrically conductive plastic, in particular an electrically conductive plastic foil.

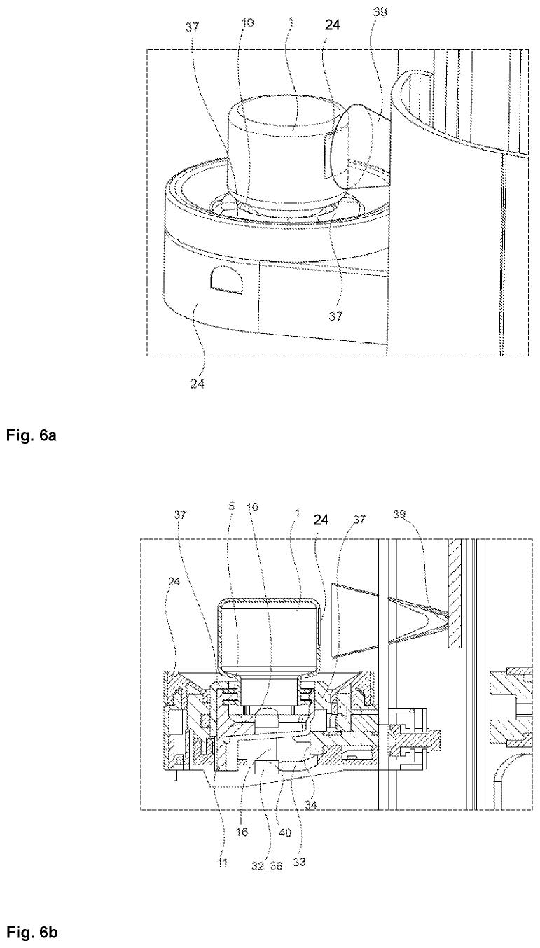

Alternatively, the cartridge receptacle shown in FIG. 2 does not comprise the identification means 20 in the form of the identification element 21 at the neck of the cartridge 2, but only the identification means 20, 24 (later also referred to as product identifier 24) in the region of the cartridge wall 2′. In this context, the identification means 20 is in particular a code, for example a marker, a pattern, a lettering, an image, a logo, a one-dimensional or two-dimensional barcode, a bitcode, a QR code, a data matrix code, a color code and/or a hologram code, which is stuck, printed or otherwise applied to the cartridge 2 and which is read out by an optical identifier detector 39 (see FIGS. 6a, 6b). Alternatively, it could be an RFID chip or magnetic element read by a corresponding identifier detector.

In any case, the identification means 20, 24 serves to check the system affiliation of the cartridge system 1 within the beverage preparation machine 3, thus to enable identification of the cartridge system 1. It is also conceivable for the identification means 20, 24 to be used to identify and, in particular, to set the cartridge system type and, in particular, operating parameters of the beverage preparation machine, such as, for example, feed rate, feed time, feed pauses, temperature, degree of carbonation and/or pressure of the fed fluid and/or the fed compressed air.

FIG. 3 shows a schematic view of the beverage preparation machine 3 shown in FIG. 1, in which the cartridge system 1 shown in FIG. 2 is inserted.

The retaining unit 90, in which the cartridge receptacle 10 is inserted, comprises a release element by means of which the piercing spike 73 can be transferred from its retracted position to an extended position.

When the piercing spike 73 is moved to an extended position, it perforates the sealing element 18, allowing the beverage substance to pass between the sealing element and the outer surface of the piercing spike 73 into the mixing chamber 8. The piercing spike 73 further comprises an integral compressed-air communication in the form of a compressed-air line 40 extending from an external compressed-air connection 42, through which compressed air is blown into the compressed-air line 40 from outside, to a compressed-air outlet 43 then located inside the reservoirs at the end of the piercing spike 73, whereby the compressed air is blown into the reservoir 6. The beverage substance is then transferred to the mixing chamber 8 by the pressure of the compressed air. The beverage is then produced in the mixing chamber 8 by mixing the beverage substance with the liquid fed by the fluid feed 12 and is discharged through the beverage outlet 11 in the direction of a drinking vessel, for example.

The retaining unit 90 is in fluid communication with a compressed-air source to feed compressed air to the compressed-air connection 42. Further, the retaining unit is in fluid communication with a fluid source to feed the fluid or the aforementioned liquid to the fluid feed.

In the embodiment in which the identification means 20 is configured as an identification element 21, the retaining unit 90 optionally further comprises two contact elements 23 which are arranged on opposite sides of the cartridge and each form a direct contact with the identification means 20 arranged on the neck. The electrical conductivity or electrical resistance of the identification element 21 or the coating 22 is measured via the contact elements 23 and the measured value is used to determine whether the cartridge system 10 inserted into the retaining unit 90 is a system-compatible cartridge system 10. Only if this test is positive, the method for producing the beverage is carried out or continued. Otherwise, the beverage preparation machine switches off, in particular immediately.

It is also conceivable for the type of cartridge system 10 to be determined on the basis of the measured conductivity value. On the basis of the type, the operating parameters stored in a memory and suitable for the type are then loaded by the machine and the beverage production process is carried out with these operating parameters.

It is also conceivable for the machine to detect on the basis of the measured conductivity value whether the cartridge 2 contains substances containing alcohol. If such an alcoholic substance is detected, the beverage preparation machine carries out an additional verification step, which is intended to determine the age and/or identification of the user, for example by means of a credit card, a fingerprint reader, facial recognition, a login or password or the like.

Optionally, it is also conceivable for the cartridge 2 to be additionally or exclusively provided with a product identifier 24 in the form of a code by means of which the type of cartridge 2 can be identified if the system affiliation of the cartridge 2 has already been verified by means of the identification means 20, thus, in particular the conductivity measurement, or as the sole identification means 20 for recognizing the system affiliation. In particular, the product identifier 24 comprises a code applied to the outer wall of the cartridge 2 or cartridge receptacle 10, such as a marker, pattern, lettering, image, logo, one-dimensional or two-dimensional bar code, bit code, QR code, data matrix code, color code, and/or hologram code.

The identification means 20 configured as a code or the product identifier 24 also serves here in particular to verify the system affiliation of the cartridge system 1 (an authentication of the cartridge system in the second method step) and optionally to indicate the beverage substance 7 contained in the cartridge 2. It is conceivable that, additionally or alternatively, operating parameters of the beverage preparation machine 3, such as, for example, feed rate, feed rate, feed time, feed pauses, start time, end time, temperature, degree of carbonation and/or pressure of the supplied fluid, thus, in particular, control parameters of the fluid feed pump, and/or of the fed compressed air, thus, in particular, control parameters of the air feed pump, are set on the basis of the product identifier 24 or the code. This is done in and by an evaluation and control unit of the beverage preparation machine 3. It is conceivable for the beverage preparation machine 3 to have a plurality of pre-stored beverage production programs that differ in the operating parameters of the beverage preparation machine 3. Each beverage production program is associated with one or more product identifiers 24. The product identifier 24 is read out by an identifier detector 39 of the beverage preparation machine 3, in particular an optical camera. The evaluation and control unit then selects the beverage preparation program corresponding to the product identifier 24. In this way, optimum operating parameters can be set for each beverage to be produced.

Alternatively, the cartridge 2 comprises only the code described above as product identifier 24, which then also represents the identification means 20. In this case, the cartridge in particular does not have the annular identification element 21 shown in FIG. 2.

FIGS. 4a to 4c show the basic principle of the method for producing a beverage with the cartridge system 1 inserted in a beverage preparation machine 3, in order to illustrate once again the general operating principle of the actual beverage production of the system according to the invention.

The present system comprises the beverage preparation machine 3 (illustrated only schematically), into which exchangeable cartridge systems 1 are insertable. Each cartridge system 1 has a cartridge 2, which is filled with a particular beverage substance 7, and a cartridge receptacle 10 connected to the cartridge 2. Within the beverage preparation machine 3, a corresponding beverage is created with the aid of the beverage substance 7 and an additional water source, referred to as fluid source 41 in the following text. The cartridge 2 is in this case preferably filled with a pre-portioned quantity of beverage substance 7 which is necessary for creating a specific drinking portion, for example a drinking glass filling of the desired beverage. In particular a plurality of different cartridge systems 1 are available, the cartridges 2 or reservoirs 6 of which are filled with different beverage substances 7 for producing different beverages. When the user of the system 1 wishes to drink a particular beverage, all he needs to do is choose, from the plurality of different cartridge systems 1, that cartridge system 1 which contains the corresponding beverage substance 7 for producing the desired beverage, insert it into a retaining unit 90 of the beverage preparation machine 3 and if appropriate start the beverage production process at the beverage preparation machine 3, for example by pressing a start button, by touching a touch sensitive display in an appropriate manner, by gesture or voice control, or by means of a suitable application on a cell phone. It is also conceivable for the beverage production process to start automatically when the insertion of a new cartridge system 1 into the retaining unit 90 is detected. In each of the abovementioned cases, the desired beverage is then produced automatically, conveyed into a drinking vessel and thus provided to the user. Subsequently, the used-up cartridge system 1 is removed and disposed of. The beverage preparation machine 3 is now ready once again to be filled with any desired new cartridge system 1 in order to produce a further beverage.

The beverage substance 7 comprises preferably liquid premixing constituents for soft drinks, such as caffeinated, carbonated, fruity and/or sugary sodas and juices, beer (mixed) drinks, or other alcoholic or nonalcoholic (mixed) drinks.

The cartridge 2 is produced in particular from plastic and by an injection blow-molding process. The cartridge 2 also has a cartridge opening 63 through which the reservoir 6 is filled with the liquid beverage substance 7. The bottom of the reservoir 6 is configured in a funnel-shaped manner in the example in, wherein the cartridge opening 63 is arranged in the center of the funnel-shaped bottom. The cartridge 2 is connected fixedly or reversibly to a cartridge receptacle 10 according to the invention. The cartridge receptacle 10 is in particular connected to the cartridge 2 by means of a latching connection 50 in the region of the cartridge opening 63 after the filling of the cartridge 2. To this end, the cartridge receptacle 10 has for example lateral latching elements 51 in the form of elastic retaining arms or a circumferential latching strip 51 (FIG. 5) which engages around one or two circumferential retaining flanges 52 of the cartridge 2 that are arranged in the region of the cartridge opening 63. The cartridge receptacle 10 is clip-fastened onto the cartridge 2 after the filling of the cartridge 2.

The cartridge receptacle 10 has a mixing chamber 8 which is fluidically connected to the reservoir 6 during the beverage production process, such that, with the aid of a cartridge emptying device 34 of the cartridge receptacle 10, the beverage substance 7 can be transferred at least partially out of the reservoir 6 into the mixing chamber 8. The cartridge emptying device 34 to this end comprises a compressed-air line 40. One end of the compressed-air line 40 is connected to a compressed-air connection 42 which can be connected to a compressed-air source 41 of the beverage preparation machine 3 in order to introduce compressed air into the compressed-air line 40, while the other end leads into a compressed-air outlet 43 which is open in the direction of the reservoir 6 and introduces compressed air into the reservoir 6. The compressed-air source 41 further preferably comprises an air-feed pump that is turned on during the beverage production process and pumps ambient air into the compressed-air line 40 toward the reservoir 6.

A fluid feed 12 of the cartridge receptacle 10, which is supplied by a fluid source 91 of the beverage preparation machine 3, also leads into the mixing chamber 8. It is conceivable for the fluid feed 12 to have a quick coupling, by way of which the fluid feed 12 can be connected to the fluid source 91 of the beverage preparation machine 3. The fluid source 91 further preferably comprises a fluid feed pump that is turned on during the beverage production process. The quick coupling can be configured for example such that, when the cartridge system 1 is inserted into the retaining unit 90, a fluidic connection is automatically established between the fluid source 91 and the mixing chamber 8 via the fluid feed 12. During the beverage production process, fluid, in particular cooled and carbonated drinking water, passes from the fluid feed 12 into the mixing chamber 8 via this fluidic connection. Furthermore, during the beverage production process, beverage substance 7 passes from the reservoir 6 into the mixing chamber 8, as described above. As a result of the beverage substance 7 being blended with the fluid in the mixing chamber 8, the beverage is formed, which then leaves the mixing chamber 8 through a beverage outlet 11.

The cartridge receptacle 10 has the beverage outlet 11, through which the beverage produced within the mixing chamber 8 leaves the mixing chamber 8, and is conveyed in particular directly into the drinking vessel (not depicted), i.e. without parts of the beverage preparation machine 3 coming into contact with the beverage. In this way, back-contamination of the beverage preparation machine 3 is prevented. The drinking vessel is arranged in particular directly beneath the beverage outlet 11.

Following completion of the beverage production process, the cartridge system 1 is removed from the retaining unit 90, such that the beverage production machine 3 can be fitted with a new and unused cartridge system 1. The cartridge receptacle 10 can be reused by being separated from the used cartridge 2 and being clip-fastened onto a new cartridge 2.

The cartridge receptacle 10 has a spike guide 80 in which a piercing spike 73 is mounted in a displaceable manner. The sealing element 18 is perforated by the displaceable piercing spike 73 being transferred between a retracted position, in which the piercing spike 73 is away from the sealing element 18 (cf. FIG. 4b), and an extended position, in which the piercing spike 73 pierces the sealing element 18 (cf. FIG. 4c) and projects into the cartridge opening 63 or into the reservoir 6.

The outer wall of the piercing spike 73 is provided with the plurality of lateral channels 71 for conveying the beverage substance 7 from the reservoir 6 in the direction of the mixing chamber 8 when the sealing element 18 is pierced. The lateral channels are configured in the form of grooves that are open on one side and extend parallel to one another. Following the piercing of the sealing element 18, the lateral channels become fluidically connected to the reservoir 6, such that the beverage substance 7 can flow around the edges of the pierced sealing element 18 in the direction of the mixing chamber 8.

The cross section of the lateral channels and/or the number of the lateral channels is in this case preferably adapted to the viscosity of the beverage substance 7, such that the lateral channels control or limit the flow of the beverage substance 7 in the direction of the mixing chamber 8. At a high viscosity, a plurality of lateral channels and/or lateral channels with a relatively large cross section are used, while, at a lower viscosity, fewer lateral channels and/or lateral channels with a smaller cross section are provided.

Furthermore integrated into the piercing spike 73 is the compressed-air line 40, which acts as the cartridge emptying device 34. The compressed-air line 40 leads into the cartridge opening 63 through a fixed compressed-air tip at the end of the piercing spike 73 when the piercing spike 73 is in the extended position. The compressed-air tip thus projects automatically into the cartridge opening 63 when the piercing spike 73 has been shifted into the extended position and has consequently pierced the sealing element 18.

On a side of the piercing spike 73 that is in particular remote from the reservoir 6, the compressed-air connection 42 is formed, which is thus accessible from outside the cartridge receptacle 10 and is connectable to the compressed-air source 41 of the beverage preparation machine 3. Preferably, the piercing spike 73 is transferred from the retracted position into the extended position during or after the insertion of the cartridge system 10 into the beverage preparation machine 3 or after the starting of the beverage production process, preferably by a fixed release element of the retaining unit 90, against which the piercing spike 73 is pushed, especially when lowering the cartridge during a handling step (see below).

Provision is preferably made for both the fluid source 91 and the compressed-air source 41 to be coupled directly to the fluid feed 12 and to the compressed-air connection 42, respectively, as soon as the cartridge system 1 is inserted into the beverage preparation machine 3 or a beverage production process is started, and in particular before the sealing element 18 is pierced. It would be conceivable that in this way, back-contamination in the direction of the beverage preparation machine 3 is effectively avoided because the fluid feed 12 and the cartridge emptying device 34 as an option are immediately under overpressure upon insertion of the cartridge system 1, and this prevents the beverage substance 7 from traveling in the direction of the fluid source 91 and compressed-air source 41, respectively. The beverage substance 7 can thus move only in the direction of the mixing chamber 8 from the reservoir 6 as soon as the sealing element 18 is opened. Preferably, however, the pressure in the fluid line is not built up until the fluid feed pump is switched on and the pressure in the compressed-air line is not built up until the air feed pump is switched on, which only takes place after the cartridge system has been successfully authenticated using the identification means by the evaluation and control unit.

The retaining unit 90 has in particular a fastening flange (see FIG. 3) which engages around the cartridge receptacle 10 in a form-fitting manner after it has been inserted into the retaining unit 90. The retaining unit 90 is preferably manually operable, for example via an operating lever 120. When a user actuates the operating lever 120, the cartridge receptacle 10 is moved relative to the beverage preparation machine 3 such that the outer end of the piercing spike 73 is pushed against a fixed release element (not illustrated) of the retaining unit 90, with the result that the piercing spike 73 moves from the retracted position into the extended position and perforates the sealing element.

The cartridge receptacle 10 has, on both sides, an at least partially circumferential latching strip by way of which the cartridge receptacle 10 is clip-fastened onto the retaining flanges 52 of the cartridge 2. Furthermore, the cartridge receptacle 10 has a mixing chamber 8, on the rear side of which the fluid feed 12 is formed in the form of a simple passage opening in the wall of the cartridge receptacle 10. On the front side, the beverage outlet 11 is formed in the bottom of the mixing chamber 8. The bottom of the mixing chamber 8 forms, in the direction of the beverage outlet 11, a continuously deepening recess such that, following completion of the beverage production process, no liquid residues remain in the mixing chamber 8. Moreover, the spike guide 80 can be seen virtually centrally within the mixing chamber 8 in FIG. 5.

The spike guide 80 comprises a guide part with an internal guide channel 110 in which the piercing spike 73 is accommodated in a displaceable manner. The guide channel 110 is formed in a substantially cylindrical manner and protrudes virtually perpendicularly from the bottom of the mixing chamber 8 in the direction of the cartridge 2. Formed at an end of the guide part that faces the cartridge 2 is a circumferential stop with a reduced diameter, against which the circumferential shoulder of the piercing spike 73 butts when the piercing spike 73 arrives in the extended position. The stop thus limits the movement of the piercing spike 73 in the direction of the reservoir 6. Optionally, mixing structures are arranged on the bottom of the mixing chamber 8.

FIG. 5 shows a schematic view of the cartridge system 1 according to further exemplary embodiments of the present invention. The cartridge system 1 shown corresponds to the cartridge system 1 shown in FIGS. 2 and 3, with only alternative examples being shown as identification means 20. Otherwise, all of the foregoing explanations apply analogously.

Thus, according to FIG. 5, the identification means 20 can be configured as a circumferential coating on the outer wall of the cartridge 2 or the cartridge receptacle 10. Furthermore, the identification means 20 can be provided as a non-circumferential coating on the outer wall of the cartridge receptacle 10 in the region of the beverage outlet 11. The identification means 20 can be read out via corresponding adapted contact elements 23.

Furthermore, the identification means 20 may be configured in the form of an identification element 21 arranged within the reservoirs 6. It is conceivable for the identification element 21 to be freely movable there or attached to the inner wall of the cartridge 2. This identification element 21 can then be read optically (in the case of a transparent beverage substance 7 and/or cartridge wall) or electromagnetically (if the identification element 21 is an RFID chip, for example) or purely magnetically (if the identification element 21 comprises a permanent magnet or a magnetic material).

FIGS. 6a and 6b again show in detail the reading of the identification means 20 and the product identifier 24, respectively, of the system according to the invention. The cartridge 1 comprises the identification means 20 (also referred to as product identifier 24) in its flattened area 38 facing the housing of the beverage preparation machine 3. The identification means 20 (or the product identifier 24) thereby preferably comprises a code, for example a marker, a pattern, a lettering, an image, a logo, a one-dimensional or two-dimensional barcode, a bitcode, a QR code, a data matrix code, a color code and/or a hologram code, in which information about the cartridge system 1 and/or the beverage substance present in the reservoir 6 is embedded. On the opposite side, an identifier detector 39 in the form of an optical camera, in particular a CCD camera, is arranged on the housing of the beverage preparation machine 3.

The code is detected by the optical camera and evaluated by an evaluation unit of the beverage preparation machine 3. In this way, the beverage preparation machine 3 recognizes or verifies whether it is an authenticated (thus, system-specific) cartridge system 1 and/or which type of cartridge 1 and/or beverage substance 7 is involved in the cartridge system 1 inserted in the retainer 24.

Based on this information, information about the preparation of the beverage using the beverage substance contained in the cartridge 1 can be loaded from an internal memory of the beverage preparation machine 3, if necessary. In particular, set values for the temporal and absolute course of the volume flow, the temperature, the pressure and/or the carbonation of the fed water or the temporal and absolute course of the volume flow and/or the pressure of the fed compressed air are specified hereby. It is also conceivable for the ratio between the volumetric flow rate of the diluent and the volumetric flow rate of the compressed air to be controlled as a function of the verified product identifier 24, in order to achieve the optimum result in terms of appearance and taste in the produced beverage for the particular cartridge type. Alternatively, it is also conceivable for the aforementioned operating parameters to be embedded in the code and taken directly from the code to control the beverage production process accordingly.

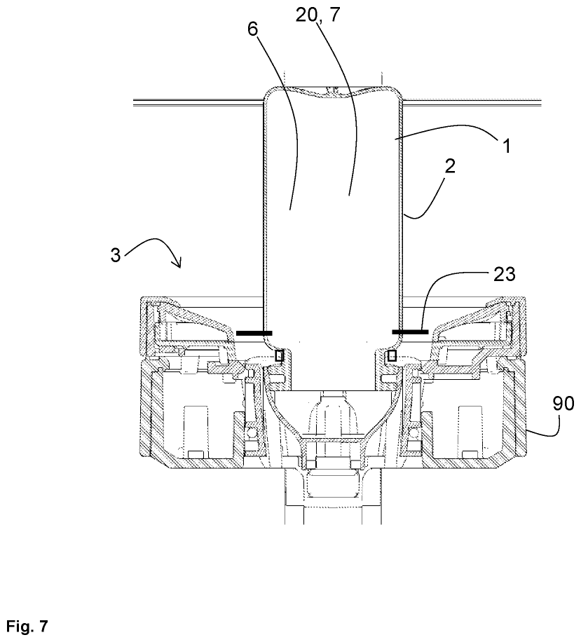

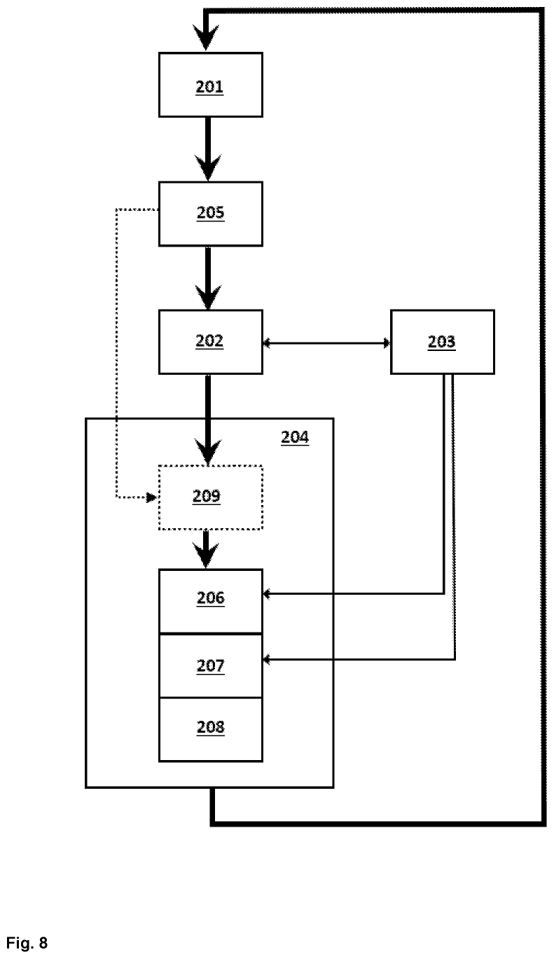

FIG. 7 shows a schematic view of the beverage preparation machine 3 illustrated in FIG. 1, in which the cartridge system 1 illustrated in FIG. 2 is inserted. The representation corresponds to the embodiment illustrated in FIG. 3, with the identification means 20 now being integrated into the beverage substance 7, which is located in the reservoir 6. The contact elements 23 pierce the cartridge wall in the region of the reservoir to come into contact with the beverage substance 7. The electrical conductivity of the beverage substance 7 is then measured via the contact elements 23 and the identification means 20 is thus evaluated. The measured electrical conductivity is then used to determine the cartridge type and start the corresponding beverage preparation program.

FIG. 8 shows a schematic view of the individual steps of the method according to the invention for producing a beverage, in particular with a beverage preparation machine and a system as explained with reference to FIGS. 1, 2, 3, 4a to 4c, 6a, 6b.

The cartridge system 1 is thereby exemplarily provided with an identification means 20 only in the form of a code, for example a marker, a pattern, a lettering, an image, a logo, a one-dimensional or two-dimensional barcode, a bitcode, a QR code, a data matrix code, a color code and/or a hologram code, or an identification means 20 in the form of an identification element 21.

In the first method step 201, the cartridge system 1 is manually inserted by a user into the beverage preparation machine 3, wherein the cartridge receptacle 10 is inserted into the corresponding retaining unit 90 of the beverage preparation machine.

In a subsequent handling step 205, the operating lever 120 is actuated by the user, whereby the release mechanism is actuated and a fastening flange of the retaining unit 90 engages around the cartridge receptacle 10 in a force-fitting and/or form-fitting manner. The cartridge system 1 is thereby moved transversely relative to the retaining unit 90, whereby the piercing spike 73 of the cartridge receptacle 10 is moved relative to a stationary release element of the retaining unit 90. The piercing spike 73 is thereby displaced from its retracted position to its extended position, thereby piercing the sealing element 18 and protruding into the reservoir 6. Furthermore, in handling step 205, this establishes a compressed-air connection between the compressed-air source of the beverage preparation machine 3 and the compressed-air connection of the cartridge receptacle 10 (this does not mean that compressed air is already blown into the reservoir 6, but only that the corresponding lines or connections are interconnected).

Furthermore, in handling step 205, a fluid connection is additionally established between a fluid source of the beverage preparation machine 3 and the fluid feed of the cartridge receptacle 10 (this does not mean that fluid is already flowing towards the mixing chamber 8, but only that the corresponding lines or connections are interconnected).

Alternatively, it is conceivable for the activation of the release mechanism not to be manual, but motor-driven by a corresponding actuator controlled by the control unit.

Subsequently, in a second method step 202, the code on the cartridge 2 is optically read by the identifier detector 39 or, alternatively, the identification means 21 is contacted by the contact element for measuring the identification means 21.

In the second method step 202, an evaluation and control unit (also referred to as a control unit) 203 of the beverage preparation machine 3 uses the detected code or read-out identification element 21 to check whether the cartridge system 1 used is a system-specific and known, thus authenticated, cartridge system 1. For this purpose, the read-out code or identification means 20 is compared with a corresponding reference or it is checked whether operating parameters can be extracted or assigned from the read-out code or identification means 20. If this check is positive, the cartridge system 1 is considered authenticated.

If an authenticated cartridge system 1 has been detected in the second method step, the beverage production process is started in a third method step 204.

The beverage preparation process includes a first preparation step 206 in which a fluid feed pump of the beverage preparation machine is first started by the evaluation and control unit 203, which feeds the fluid from a fluid tank (in particular, a removable water tank) through a heat exchanger to cool the fluid and through a flow-through carbonator to carbonate the cooled fluid into the mixing chamber of the cartridge receptacle 10.

In particular, after waiting for a period of time between 1 millisecond and 2 seconds, preferably between 100 milliseconds and 1.5 seconds, and particularly preferably from 500 milliseconds to 1 second after switching on the fluid feed pump, in a second preparation step 207 the air feed pump of the beverage preparation machine 3 is switched on by the evaluation and control unit 203, which draws in ambient air through an air inlet and pumps it through the compressed air line 40 as compressed air into the reservoir 6.

It is conceivable for the starting time, stopping time, running time and/or feed rate of the fluid feed pump and/or the air feed pump and/or the time period to be waited between the start of the fluid feed pump and the air feed pump to be read out as operating parameters from the code or the identification means 20, and for the evaluation and control unit 203 to control the first and second preparation steps 206 and 207 accordingly.

By feeding the compressed air into the reservoir 6, in a third preparation step 208, the beverage substance 7 is then transferred from the reservoir 6 into the mixing chamber 8 and mixed there with the fluid, whereby the beverage is formed in the mixing chamber, which is dispensed from the mixing chamber 8 via the beverage outlet 11 into a drinking vessel.

As an alternative to the sequence described above, the handling step 205 can be carried out instead of between the first and second method steps 201 and 202 as the zeroth preparation step 209 as part of the beverage preparation process. This has the advantage that opening of the cartridge system 1 by means of the release element does not take place until the cartridge system 1 has been authenticated by the evaluation and control unit 203 on the basis of the code or identification means 20.

After the third preparation step 208 has been completed, the air feed pump and the fluid feed pump are stopped simultaneously or successively, preferably first the air feed pump and then the fluid feed pump being switched off. Thereafter, the release mechanism can be released manually via the operating lever or motorized or returned to its initial position so that the used capsule system 1 can be removed from the retaining unit 90. The beverage preparation machine 3 is now ready for a new cycle, which in turn starts with the first method step 201.

### LIST OF REFERENCE SIGNS

1 Cartridge system
2 Cartridge
3 Beverage preparation machine
6 Reservoir
7 Beverage substance
8 Mixing chamber
10 Cartridge receptacle
11 Beverage outlet
12 Fluid feed
18 Sealing element
20, 24 Identification means
21 Identification element
22 Coating
23 Contact elements
24 Product identifier
34 Cartridge emptying device
39 Identifier detector
40 Compressed-air line
42 Compressed-air connection
43 Compressed-air outlet
52 Retaining flange
63 Cartridge opening
73 Piercing spike
80 Spike guide
90 Retaining unit
110 Guide channel
120 Operating lever

1. A cartridge system for producing a beverage, wherein the cartridge system can be inserted into a beverage preparation machine, wherein the cartridge system has a cartridge, which comprises a reservoir filled with a beverage substance, and a cartridge receptacle connected to the cartridge, wherein the cartridge receptacle comprises a mixing chamber that can be brought into fluid connection with the reservoir and a fluid feed opening into the mixing chamber, wherein the cartridge system comprises an identification means comprising an identification element for identifying the cartridge system in the beverage preparation machine, and wherein the identification element is arranged within the reservoir and/or the mixing chamber.

2. The cartridge system as claimed in claim 1, wherein the identification means comprises a coating on an inner surface of the cartridge and/or the cartridge receptacle.

3. (canceled)

4. (canceled)

5. The cartridge system as claimed in claim 1, wherein the identification means is arranged along a longitudinal axis of the cartridge system between the reservoir and the mixing chamber.

6. The cartridge system as claimed in claim 1, wherein the identification element is connected to the cartridge, the cartridge receptacle, and/or a neck of the cartridge in a force-fitting, material-fitting, and/or form-fitting manner.

7. The cartridge system as claimed in claim 1, wherein the identification element is integrally connected to and/or is integrated into the cartridge, the cartridge receptacle, and/or a neck of the cartridge.

8. (canceled)

9. The cartridge system as claimed in claim 1, wherein the identification means is an optically readable code arranged on an inside of an at least partially optically transparent wall of the reservoir or the mixing chamber.

10. (canceled)

11. (canceled)

12. (canceled)

13. (canceled)

14. The cartridge system as claimed in claim 1, wherein the beverage substance acts as the identification means.

15. The cartridge system as claimed in claim 1, wherein the cartridge receptacle comprises a compressed-air connection opening into the reservoir for introducing compressed air into the reservoir.

16. A beverage preparation machine for producing a beverage, in which the cartridge system according to claim 1 can be inserted, wherein the beverage preparation machine comprises a retaining unit, in which the cartridge receptacle connected to the cartridge can be inserted.

17. The beverage preparation machine as claimed in claim 16, wherein the retaining unit comprises at least one contact element contacting the identification means of the cartridge system to determine at least one physical parameter of the identification means for identifying the cartridge system.

18. The beverage preparation machine as claimed in claim 17, wherein the beverage preparation machine comprises a measuring unit connected to the at least one contact element for measuring electrical resistance and/or electrical conductivity of the identification means.

19. The beverage preparation machine as claimed in claim 18, wherein the contact element comprises a piercing tip which pierces a wall of the cartridge system to contact the identification means when measuring the at least one physical parameter.

20. The beverage preparation machine as claimed in claim 16, wherein the beverage preparation machine comprises a fluid source for feeding a fluid into the fluid feed and a compressed-air source for blowing compressed air into a compressed air connection.

21. The beverage preparation machine as claimed in claim 16, wherein the retaining unit comprises a release element for transferring a piercing means of the cartridge receptacle from a retracted position to an extended position.

22. The beverage preparation machine as claimed in claim 16, wherein the retaining unit comprises a fastening flange which engages around the cartridge receptacle in a form-fitting and/or force-fitting manner during or after insertion into the retaining unit.

23. The beverage preparation machine as claimed in claim 22, wherein the contact element is integrated into the fastening flange.

24. A system comprising a beverage preparation machine as claimed in claim 16 and a cartridge system insertable into the retaining unit.

25.-38. (canceled)

39. The cartridge system as claimed in claim 2, wherein the coating, is in a form of a lacquer, an imprint, or a foil, on an inner surface of the cartridge and/or the cartridge receptacle.

40. The cartridge system as claimed in claim 6, wherein the identification element is stuck, welded, latched, and/or pressed to the cartridge, the cartridge receptacle, and/or the neck of the cartridge.

41. The cartridge system as claimed in claim 9, wherein the optically readable code is a one- or multi-dimensional barcode, a pattern, or a hologram.
